(19) United States
(12) Patent Application Publication
(10) Pub. No.: US 2011/0148898 A1
(43) Pub. Date: Jun. 23, 2011

(54) APPARATUS AND METHOD FOR PROCESSING COMPLEX MATERIAL APPEARANCE INFORMATION

(75) Inventor: Joo Haeng LEE, Daejeon (KR)

(73) Assignee: Electronics and Telecommunications Research Institute, Daejeon (KR)

(21) Appl. No.: 12/974,833

(22) Filed: Dec. 21, 2010

(30) Foreign Application Priority Data
Dec. 21, 2009 (KR) 10-2009-0127700
Mar. 16, 2010 (KR) 10-2010-0023434

(51) Int. Cl. G09G 5/00

(52) U.S. Cl. 345/582; 345/581

(57) ABSTRACT

The present invention relates to an apparatus for processing material appearance information. The apparatus for processing material appearance information according to an exemplary embodiment of the present invention includes: a material appearance information inputting unit that receives material appearance information of each layer of multi-layered material; a material appearance information processor that processes material appearance information of each layer; and a rendering unit that performs rendering by using results of the material appearance information process.

### CROSS-REFERENCE TO RELATED APPLICATIONS

This application claims priority under 35 U.S.C. §119 to Korean Patent Application No. 10-2009-0127700, filed on Dec. 21, 2009, and Korean Patent Application No. 10-2010-0023434, filed on Mar. 16, 2010 in the Korean Intellectual Property Office, the disclosure of which is incorporated herein by reference in its entirety.

### BACKGROUND OF THE INVENTION

1. Field of the Invention

The present invention relates to an apparatus for processing material appearance information by processing and visualizing material appearance information on each layer.

2. Description of the Related Art

With the rapid development of 3-dimensional computer graphics technology, image synthesis can be made at the same or similar level to photographed images. In particular, the image synthesis has been used in the fields, such as mobile devices and home appliances using various new materials, fashion, car, visualizing design in the field of architecture, image special effect field requiring real image synthesis, etc. However, there are disadvantages in that computing time of a computer and working time of a designer are very long in order to generate the images. Therefore, in order to solve the problems, many researches including technology development have been made.

The material appearance is important among many factors determining reality of computer generated imagery (CGI). In particular, many factors should be considered in order to render complex material appearance such as body portions, for example, skin or hair, delicate cloth, mixed paint, etc.

Various technologies have been developed in order to render such information. For example, characteristics of the material appearance are obtained as raw data by photographing the surface of the real object.

Alternatively, this may be rendered by using an Equation that establishes a physical model and an empirical model. However, in case of raw data, the characteristics of the material appearance are accurately rendered but the size of raw data is very large such that it is difficult to use raw data in a network render farm environment using several hundreds to thousands of CPUs. This is disadvantageous in that limitation exists in rendering the characteristics of delicate material appearance by using only an Equation-based model, in addition to increasing the amount of computation.

It is important to edit or collect the existing material appearance information or generate new material appearance information. In particular, even though the measured material appearance is only used as reference materials, various tests are required. To this end, a need exists for an editing system that supports the mixing of the material appearance. In particular, since a multi-layered material is mainly used during a process of manufacturing the external appearance of a product, it is important to visualize the material appearance information.

Consequently, the detailed material appearance information has large data and a large amount of computation is frequent. Therefore, a need exists for a method capable of using precise material appearance information in a large region that is well visible to the naked eye and simplified material appearance information in a small region that is not visible to the naked eye. To this end, it is necessary to support the material appearance information in a multiple resolution.

Meanwhile, the apparatus and method for processing material appearance information according to the related art can process only single-layered surface materials. Therefore, it is difficult to effectively process material appearance information of the multi-layered material by the apparatus and method for processing material appearance information according to the related art. Further, the apparatus and method for processing material appearance according to the related art cannot control the speed and accuracy of rendering while processing and visualizing the material appearance information of the multi-layered material.

### SUMMARY OF THE INVENTION

It is an object of the present invention to provide an apparatus and a method for processing and visualizing material appearance information of a multi-layered material.

The present invention is not limited to the above-mentioned object and other objects, which are not described above, can be obviously understood to those skilled in the art from the following description.

In order to achieve the above object, according to an exemplary embodiment, there is provided an apparatus for processing material appearance information including: a material appearance information inputting unit that receives material appearance information of each layer of multi-layered material; a material appearance information processor that processes material appearance information of each layer; and a rendering unit that performs rendering by using results of the material appearance information process.

According to another exemplary embodiment, there is provided an a material appearance information inputting unit that receives material appearance information of each layer of a multi-layered material; a material appearance information processor that processes the material appearance information of each layer and converts it into a B-spline volume type; and a rendering unit that performs rendering by using results of the material appearance information processor.

There is provided a method for processing material appearance information, including: receiving material appearance information of each layer of a multi-layered material; processing material information of each layer; and performing rendering by using the results of the processing.

The details of other exemplary embodiments are included in the detailed description and the drawings.

According to the present invention, the apparatus for processing material appearance information according to the exemplary embodiment of the present invention can process and visualize the material appearance information forming a multi-layered material. Further, the apparatus and method for processing material appearance according to the exemplary embodiment of the present invention can control the speed and accuracy of rendering while processing and visualizing the material appearance information of the multi-layered material.

### BRIEF DESCRIPTION OF THE DRAWINGS

FIG. 1 is a block diagram showing an apparatus of processing material appearance information according to an exemplary embodiment of the present invention;

FIG. 2 is a block diagram showing an apparatus of processing material appearance information according to another exemplary embodiment of the present invention;

FIG. 3 is a block diagram showing an exemplary embodiment of a material appearance information processing unit in the apparatus for processing material appearance information according to the exemplary embodiments of the present invention;

FIG. 4 is an exemplified diagram showing an exemplary embodiment of a level considering a light tracing path in the apparatus and method for processing material appearance information according to the exemplary embodiments of the present invention;

FIG. 5 is an exemplified diagram showing another exemplary embodiment of a level considering a light tracing path in the apparatus and method for processing material appearance information according to the exemplary embodiments of the present invention; and

FIG. 6 is an exemplified diagram showing still another exemplary embodiment of a level considering a light tracing path in the apparatus and method for processing material appearance information according to the exemplary embodiments of the present invention.

### DETAILED DESCRIPTION OF THE PREFERRED EMBODIMENTS

Advantages and features of the present invention and methods to achieve them will be elucidated from exemplary embodiments described below in detail with reference to the accompanying drawings. However, the present invention is not limited to exemplary embodiment disclosed herein but will be implemented in various forms. The exemplary embodiments is provided by way of example only so that a person of ordinary skilled in the art to fully understand the disclosures of the present invention and the scope of the present invention. Therefore, the present invention will be defined only by the scope of the appended claims. Meanwhile, terms used in the present invention are to explain exemplary embodiments rather than limiting the present invention. In the specification, a singular type may also be used as a plural type unless stated specifically. The term “comprises” and/or “comprising” used herein does not exclude the existence or addition of one or more other components, steps, operations and/or elements.

Hereinafter, preferred embodiments of the present invention will be described in detail with reference to the accompanying drawings.

Exemplary embodiments of the present invention has a case where material appearance information made of specific materials (for example: gold, plastic, etc.) is given in a bi-directional reflectance distribution function (BRDF) form.

The bi-directional reflectance distribution function is a ratio of reflected light to an amount of light incident on a specific material. The material appearance made of specific materials is determined according to how much incident light is reflected in any direction. Therefore, the bi-directional reflectance distribution function is a very important factor that determines the material appearance. In addition, the important factors are the amount of incident light, the amount of reflected light, or the frequency and direction of incident or reflected light, etc.

The basic bi-directional reflectance distributions function is defined by two vectors with respect to one point. In other words, it is a unit vector ωᵢ of light incident from a point to a light source and a unit vector ωₑ reflected from a point to an eye or a camera.

A spatial unit vector ω is represented by two variables at a polar coordinate system. At a ω=(θ,φ) polar coordinate system, an inverse altitude measured from a zenith represented by θ and an azimuth is represented by φ. The range of the inverse altitude is 0° to 90° and the range of the azimuth is 0° to 360°. Therefore, the domain of the basic bi-directional reflectance distribution function is a four-dimensional function defined for four variables (θₑ, φₑ; θᵢ, φᵢ).

The extended bi-directional reflectance distribution function may be further defined by the order, thickness, and temperature of each layer, the frequency of incident light, and the frequency of reflected light, etc. Therefore, the extended bi-directional reflectance distribution function can be five-dimensional function or more.

The material appearance information used in the exemplary embodiments of the present invention is not affected by the dimension of the domain of the BRDF function. In other words, the exemplary embodiments of the present invention can be extended to any dimension. The reason is that this can support the high-dimensional B-Spline Volume.

Generally, the B-spline is used to render a curved line or a curved surface in computer graphics or CAD fields. The case representing the curved line can be considered as one dimension and the case representing the curved surface can be considered as two-dimension. This corresponds to a minimum number of parameters or a dimension of a domain. The exemplary embodiments of the present invention can be used by extending the existing B-spline to three-dimensions or more. This is referred to as the B-spline volume.

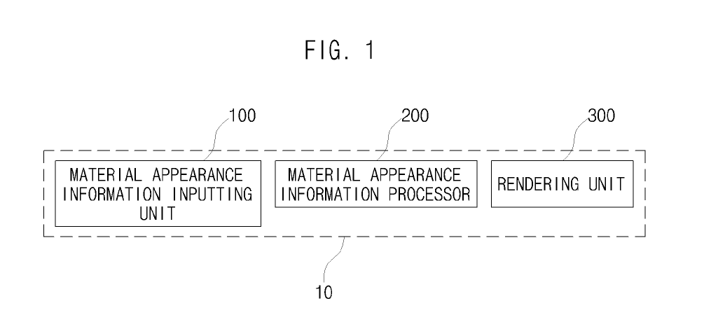

An apparatus of processing material appearance information according to an exemplary embodiment of the present invention will be described with reference to FIG. 1. FIG. 1 is a block diagram showing an apparatus of processing material appearance information according to an exemplary embodiment of the present invention.

As shown in FIG. 1, an apparatus 10 for processing material appearance information includes a material appearance information inputting unit 100, a material appearance information processing unit 200, and a rendering unit 300.

Meanwhile, the material appearance information inputting unit 100 receives the material appearance information of each layer of a multi-layered material.

Further, the material appearance information processing unit 200 processes the material appearance information of each layer.

Further, the rendering unit 300 performs rendering by using the results of the material appearance information processing unit 200.

The apparatus for processing material appearance information according to the exemplary embodiment of the present invention can process and visualize the material appearance information of the multi-layered material.

For example, each layer of a surface of a painted car has different materials. Raw materials such as a steel plate are placed at the bottom layer of the surface and paint and coating materials are placed at the layer thereon. In this case, the apparatus for processing material appearance information according to the exemplary embodiment of the present invention receives the material appearance information of raw materials, paint, and coating materials from the material appearance information inputting unit 100 and processes the material appearance information of each layer in the material appearance information processing unit 200. In addition, the rendering unit 300 performs rendering by using the results. Therefore, the apparatus for processing material appearance information according to the exemplary embodiment of the present invention can process and visualize the material appearance information of the multi-layered material.

Meanwhile, the characteristics of each layer determining the material appearance may be at least one of bi-directional distribution function (BRDF), refractive index, absorption coefficient, reflection coefficient, thickness, order of each layer, roughness of surface, and color.

Meanwhile, the characteristics of materials of each layer may be input by a user. The characteristics of materials of each layer can be measured and input by using an apparatus such as a camera or a spectroscope for the specific material appearance. At this time, the characteristics of materials of each layer can receive the previously output value input from a mathematical model and a physical model. In addition, the characteristics of materials of each layer can receive values output from a table type model, a B-spline type model, an empirical model, a mathematical model, and a physical model. Furthermore, the characteristics of materials of each layer can receive values output from the results generated by mixing two or more material appearances. Then, the characteristics of materials of each layer is converted into the bi-directional distribution function (BRDF) and input.

The material appearance information inputting unit 100 receives at least one of the measured material appearance information, the mathematical material appearance information, and the material appearance information of a material appearance network and can process the material appearance information of each layer by using each information and convert it into the B-spline volume type.

Meanwhile, the material appearance inputting unit 100 may further receive at least two material appearance information. The material appearance information processing unit 200 may interpolate two or more material appearance information and generate intermediate material appearance information to process the material appearance information of each layer.

For example, the intermediate material appearance information is generated by mixing the material appearance of gold and silver.

In this case, if the material appearance type of two or more material appearance information is the same as each other (for example, Lafortune model), the material appearance information may be processed by interpolating parameters of the material appearance type.

Meanwhile, the material appearance type may be selected from a table type that lists the measured material appearance information as a raw data type. Further, the material appearance type may be the B-spline type. Alternatively, the material appearance type may be the empirical model such as Phong, Blinn, Ward, Lafortune models. In addition, the material appearance type may be the mathematical model type and the physical model type such as Cook-Torrance, Oren-Nayar.

The parameters of the material appearance type may be changed by the input of the user.

Meanwhile, in order to generate and process various material appearance information, the material appearance types of each material appearance information are not necessarily the same.

In addition, in the case of performing the rendering in the rendering unit 300, the material appearance information processing unit 200 can convert the results of the mixed material appearance information into a predetermined material appearance type for effective calculation.

For example, when the material appearance information processing unit 200 interpolates the material appearance information having the physical model and the material appearance information in the B-spline type and generates the intermediate material appearance information, the results may be converted into the B-spline type and the rendering unit 300 may perform rendering by using the converted material appearance information.

Further, the material appearance inputting unit 100 further receives at least two material appearance information and the material appearance information processing unit 200 may separate two or more material appearance information according to an incident angle or a reflecting angle for each layer to process the material appearance information of each layer.

For example, when the incident angle is 45° or more, the material appearance information processing unit 200 may perform a process to show the material appearance of gold and when the incident angle is 45° or less, it may perform a process to show the material appearance of plastic.

Meanwhile, the material appearance information processing unit 200 may be at least one of bi-directional distribution function of each layer, thickness of each layer, refractive index of each layer, absorption coefficient of each layer, and reflection coefficient of each layer.

Further, the material appearance information processing unit 200 may process at least one of an order of each layer, surface roughness of each layer, color of each layer, an amount of light incident to each layer, an amount of light reflected from each layer, temperature of each layer, frequency of incident light, and frequency of reflected light.

In addition, the material appearance information processing unit 200 processes the material appearance information of each layer and can convert it into the B-spline volume type.

The material appearance information processing unit 200 evaluates the B-spline for the material appearance information in respects to the B-spline volume type to find out the bi-directional reflectance distribution function. Meanwhile, the material appearance information processing unit 200 may include software, GPU, dedicated hardware, etc., in order to evaluate the B-spline.

In this case, the information converted into the B-spline volume type may include the bi-directional reflectance distribution function of each layer. Further, the information converted into the B-spline volume type may include at least one of thickness of each layer, refractive index of each layer, absorption coefficient of each layer, reflection coefficient of each layer, an order of each layer, surface roughness of each layer, color of each layer, an amount of light incident to each layer, an amount of light reflected from each layer, temperature of each layer, frequency of incident light, and frequency of reflected light.

Meanwhile, the rendering unit 300 may perform rendering by controlling the speed and accuracy of the rendering according to a level considering the light tracing path tracing the incident and reflecting paths of light from the materials of each layer.

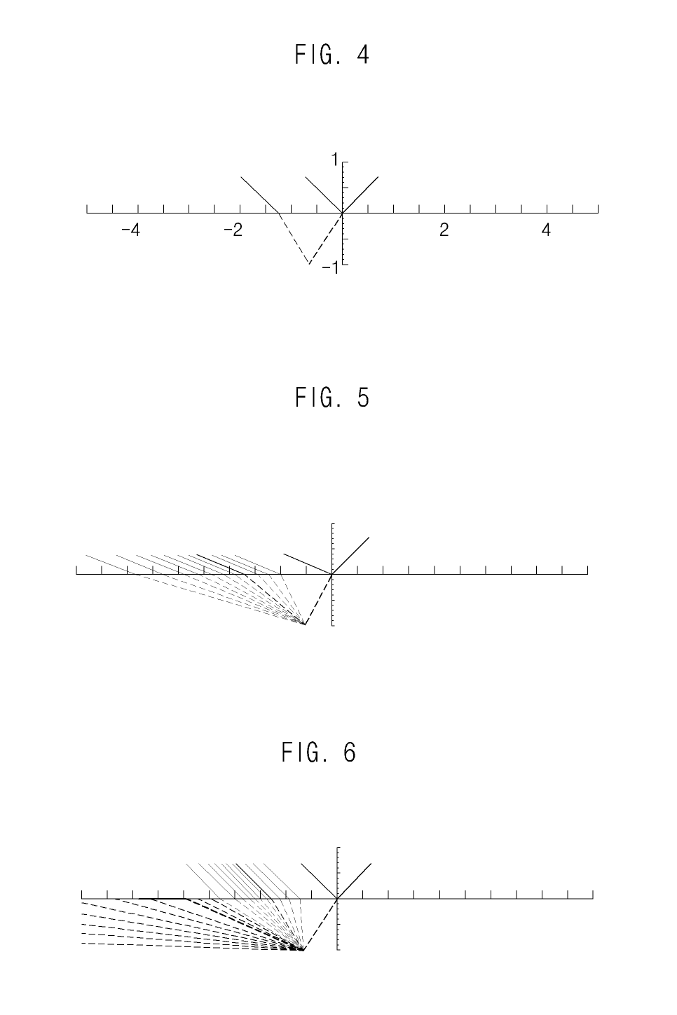

Referring to FIG. 4, another exemplary embodiment of the present invention of a level considering the light tracing path of the rendering unit 300 according to the exemplary embodiment of the present invention will be described. FIG. 4 is an exemplified diagram showing an exemplary embodiment of a level considering a light tracing path in the apparatus and method for processing material appearance information according to the exemplary embodiments of the present invention.

The rendering unit 300 may perform rendering in the direction of the reflected light by calculating a possible refractive direction of the incident light from the fixed point.

Referring to FIG. 4, the figure shows that incident light with respect to a direction of light reflected from one fixed point may have more than two directions of light reflected through the upper layer portion reflecting point and the lower layer portion reflecting point.

Referring to FIG. 4, the direction of the reflected light is shown in 1 quadrant and the direction of the incident light is shown in 2 quadrants. In addition, the case where the incident light is refracted and then reflected from the lower layer portion reflecting point is shown in 3 quadrants.

At this time, the direction of the incident light refracted in the direction of the reflected light is refracted through the lower layer portion reflecting point from the fixed point. Therefore, the rendering unit 300 may perform rendering on the direction of the incident light by calculating the possible refractive direction of the incident light from the fixed point.

In other words, when the direction of light reflected toward a camera or an eye is defined, the rendering unit 300 may perform rendering on light refracted in the defined direction by calculating the direction of the incident light.

Referring to FIG. 5, another exemplary embodiment of a level considering the light tracing path of the rendering unit 300 according to the exemplary embodiments of the present invention will be described. FIG. 5 is an exemplified diagram showing another exemplary embodiment of a level considering the light tracing path in the apparatus and method for processing material appearance information according to the exemplary embodiments of the present invention.

The rendering unit 300 may perform rendering in the direction of the incident light by calculating the possible refractive direction of the incident light from the fixed point. In this case, the refractive index at the upper layer portion reflecting point of the multi-layered material and the normal direction of the reflected light are fixed, such that the rendering unit 300 uses the same lower layer portion reflecting point for the path of each light. In addition, the rendering unit 300 performs the rendering by calculating the possible refractive direction of light. Meanwhile, the rendering unit 300 may perform rendering by calculating the possible refractive direction of incident light by using the fact that the materials of the upper layer portion and the lower layer portion form the statistical normal direction.

Referring to FIG. 5, the direction of the reflected light is shown in 1 quadrant and the direction of the incident light is shown in 2 quadrants. In addition, the case where the incident light is refracted and then reflected from the reflecting point of the lower layer portion is shown in 3 quadrants.

At this time, the direction of the incident light refracted in the direction of the reflected light is refracted to have the same lower layer portion reflecting point from the fixed point. Therefore, the rendering unit 300 may perform rendering in the direction of the incident light by calculating the possible refractive direction of the incident light from the fixed point.

Referring to FIG. 6, another exemplary embodiment of a level considering the light tracing path of the rendering unit 300 according to the exemplary embodiments of the present invention will be described. FIG. 6 is an exemplified diagram showing still another exemplary embodiment of a level considering a light tracing path in the apparatus and method for processing material appearance information according to the exemplary embodiments of the present invention.

In addition, as another embodiment of a level considering the light tracing path of the rendering unit 300 according to the exemplary embodiments of the present invention, the rendering unit 300 may perform rendering by calculating the freely changeable case without fixing the direction of the incident light. In this case, however, the lower layer portion reflecting point is set to be fixed. In this case, the rendering unit 300 can consider the possible refractive direction of incident light from a wider region while performing the rendering.

Referring to FIG. 6, the direction of the reflected light is shown in 1 quadrant and the direction of the incident light is shown in 1-quadrant and 2 quadrants. In addition, the case where the incident light is refracted and then reflected from the reflecting point of the lower layer portion is shown in 3 quadrants.

At this time, the rendering unit 300 calculates the freely changeable case without fixing the direction of incident light refracted in the direction of the reflected light. Therefore, the rendering unit 300 considers the possible refractive direction of the incident light refracted to have the same lower layer portion reflecting point from a wider region. The rendering unit 300 may perform rendering by calculating the freely changeable case without fixing the direction of incident light.

In addition, as another embodiment of a level considering the light tracing path of the rendering unit 300 according to the exemplary embodiments of the present invention, the rendering unit 300 may perform rendering by calculating the freely changeable case without fixing the lower layer portion reflecting point and the direction of the incident light. In this case, the rendering unit 300 can perform rendering with high accuracy.

Meanwhile, in all the above-mentioned cases, the calculation of the possible refraction of the incident light can be made by allowing the rendering unit 300 to perform Monte Carlo integration by sampling the direction component (for example, bi-directional reflectance distribution function) of incident light.

The rendering unit 300 may perform the importance of the material appearance information or the importance sampling that is relatively subjected to many samplings in the region having a large value. For example, in the case of the material appearance, the rendering unit 300 can perform many samplings in the region having a large value of the bi-directional reflectance distribution function.

Further, the sampling may be independently performed for each color element and predetermined frequency region of a color model (for example, RGB color model).

In other words, when the direction of light reflected toward a camera or an eye is defined, the rendering unit 300 may perform the light tracing and the rendering by mainly sampling the direction of the incident light where light is relatively greatly refracted in this direction. Meanwhile, the rendering unit 300 may use the conversion mechanism using a Marginal density function when the bi-directional reflectance distribution function becomes too complex in performing the rendering.

In the exemplary embodiment of the present invention, the rendering unit 300 calculates the Marginal density function for the inverse altitude value and the azimuth value of the bi-directional reflectance distribution function of the material showing the specific material appearance and stores it in the material structure such as a Hash table, etc., and can use it as the inverse function type. In this case, a cosine value for the inverse altitude value may be applied as a weight value in terms of the characteristics of the rendering Equation. Further, the inverse function value for the input of one-dimensional random number generator is easily searched. The rendering unit 300 may use the searched results in performing the sampling.

Meanwhile, the rendering unit 300 may convert the sampled data into any one of the raw data, the B-spline volume type, the empirical model, the mathematical model, and the physical model in performing the rendering.

Meanwhile, the rendering unit 300 may use Cosine Weighted Uniform Hemisphere Sampling in performing the rendering.

Further, the rendering unit 300 converts only the knot vector and the control point into the Hash table, etc., through the B-spline volume to increase the inverse function searching speed, thereby making it possible to effectively perform rendering.

In addition, the rendering unit 300 can directly calculate the Marginal density function by mathematically integrating the B-spline volume. In this case, the rendering unit 300 can use integration of the basic function in order to mathematically perform the integration.

Further, the rendering unit 300 may perform rendering in consideration of the order of each layer and the characteristics of materials of each layer. As described above, in the case of tracing the incident and reflected directions of light, the rendering unit 300 may perform rendering by dividing the order of each layer into the upper layer portion and the lower layer portion and considering the order of each layer.

Meanwhile, dividing the order of each layer into the upper layer portion and the lower layer portion is relative. For example, in case of the multi-layered material such as glass, paint, and plastic in this order, the glass material corresponds to the upper layer portion and the paint material corresponds to the lower layer portion, in connection with the paint material. Further, the paint material corresponds to the upper layer portion and the plastic material corresponds to the lower layer portion, in connection with the plastic material.

The rendering unit 300 may perform rendering in consideration of at least one of the bi-directional distribution function (BRDF), the refractive index, the absorption coefficient, and the reflection coefficient among the characteristics of materials of each layer.

Meanwhile, the order of each layer processed and the characteristics of materials of each layer processed may be changed by the input of the user. In this case, the rendering unit 300 may perform rendering by using the changed results by the input of the user.

Meanwhile, the rendering unit 300 may perform rendering by using the B-spline volume bi-directional distribution function.

Meanwhile, the rendering unit 300 processes the material appearance by using the given scene information, thereby making it possible to perform rendering. At this time, the scene information includes all the elements other than the material appearance information. For example, it corresponds to a shape of material, lighting, camera, texture, etc. In this case, the scene information may be the type of bi-directional reflectance distribution function. In addition, the scene information may be provided using a shader network.

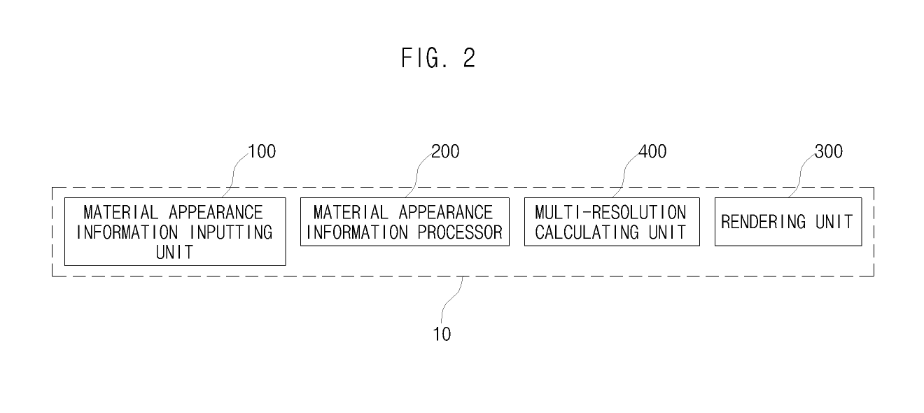

The apparatus of processing material appearance information according to another exemplary embodiment of the present invention will be described with reference to FIG. 2. FIG. 2 is a block diagram showing an apparatus of processing material appearance information according to another exemplary embodiment of the present invention.

Herein, components of performing the same functions as components shown in FIG. 1 are denoted by the same reference numerals and therefore, the detailed description thereof will be omitted.

As shown in FIG. 2, an apparatus 20 for processing material appearance information includes a material appearance information inputting unit 100, a material appearance information processing unit 200, a multi-resolution calculating unit 400, and a rendering unit 300.

Meanwhile, the material appearance information inputting unit 100 receives the material appearance information of each layer of the multi-layered material.

The material appearance information processing unit 200 processes the material appearance information of each layer.

Further, the multi-resolution calculating unit 400 controls the number of control points of the bi-directional reflectance distribution function according to the level of the user desired multi-resolution to generate the B-spline volume bi-directional distribution function from the results of the material appearance information processing unit 200.

The rendering unit 300 performs rendering by using the results of the material appearance information processing unit 200. Meanwhile, the rendering unit 300 may perform rendering by using the B-spline volume bi-directional distribution function.

Therefore, the apparatus for processing material appearance information according to the exemplary embodiment of the present invention can process and visualize the material appearance information of the multi-layered material. In addition, the apparatus for processing material appearance information according to another embodiment of the present invention can process and visualize the material appearance information efficiently and faster by using the B-spline volume and the B-spline volume bi-directional reflectance distribution function.

Meanwhile, the multi-resolution calculating unit 400 can receive at least one of the number of control points, the steps of multi-resolution, maximum value, and minimum value in order to control the number of control points of the bi-directional reflectance distribution function. In addition, the multi-resolution calculating unit controls the number of control points by using the value received from the user to generate the B-spline volume bi-directional reflectance distribution function. For example, when the number of control points is four and the steps of multi-resolutions are input in four steps, it can generate the B-spline volume bi-directional distribution function while changing the number of control points into four (20,80,20,80), (15,60,15,60), (10,40,10,40), (5,20,4,20).

Therefore, the apparatus for processing material appearance information according to the exemplary embodiment of the present invention can process the material appearance information of the multi-layered material and visualize it with the multi-resolution. Therefore, the apparatus for processing material appearance information according to the exemplary embodiment of the present invention can process and visualize the material appearance information more efficiently and faster.

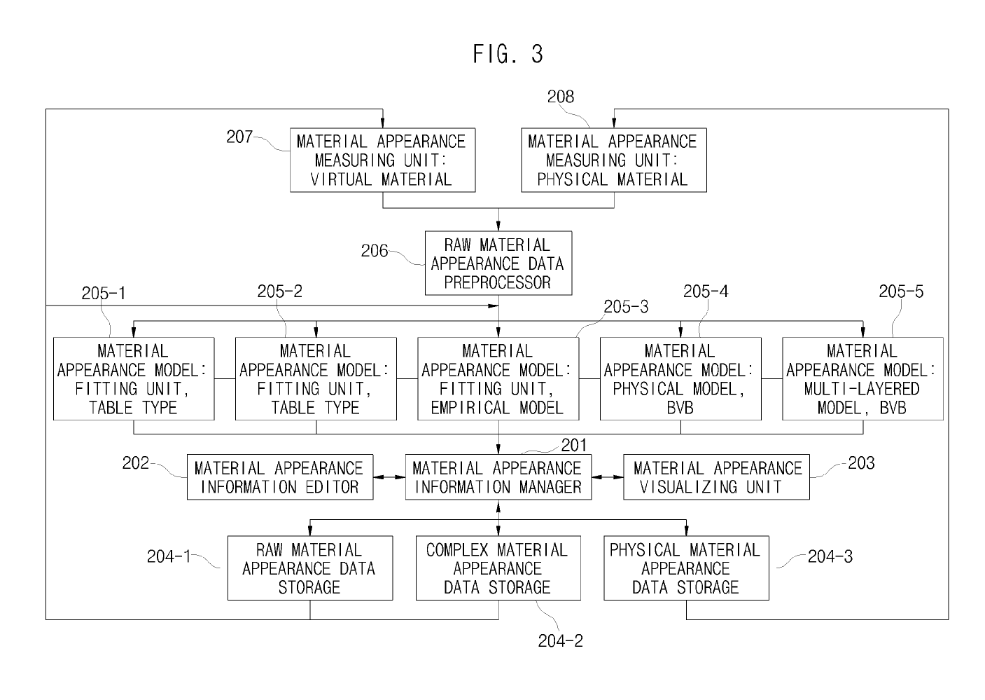

FIG. 3 shows an exemplary embodiment of a material appearance information processor in the apparatus for processing material appearance information according to the exemplary embodiments of the present invention. FIG. 3 is a block diagram showing an exemplary embodiment of a material appearance information processor in the apparatus for processing material appearance information according to the exemplary embodiments of the present invention;

In all the above-mentioned cases, one embodiment of the material appearance information processing unit 200 according to the apparatus of processing material appearance information includes a material appearance information manager 201, a material appearance information editor 202, a material appearance information visualizing unit 203, a raw material appearance data storage 204-1, a complex material data storage 204-2, a physical material data storage 204-3, a material model fitting unit 205-1 for a table type, a material model fitting unit for the BVB 205-2, a material model fitting unit for an empirical model 205-3, a material model fitting unit 205-4 for a physical model, a material model fitting unit 205-5 5 for a multi-model, a B-spline volume raw material appearance data preprocessor 206, a virtual material measuring unit 207, and a physical material measuring unit 208.

The material appearance information manager 201 receives the material appearance information from the material appearance information editor 202, the material appearance information visualizing unit 203, the material data storage 204, and the material appearance model fitting unit 205 and manages the material appearance information and provides the material appearance information to the material appearance information editor 202 and the material appearance information visualizing unit 203.

The material appearance information editor 202 may receive the material appearance information from the material appearance information manager 201 to process the material appearance information.

Meanwhile, the material appearance information editor 202 may process the material appearance information by interpolating more than two material appearance information and generating the intermediate material appearance information.

In addition, the material appearance information editor 202 may separate more than two material appearance information for each incident angle or reflected angle of light for each layer to process the material appearance information.

Further, the material appearance information editor 202 may process at least one of each layer, the surface roughness of each layer, the color of each layer, the amount of light incident to each layer, the amount of light reflected from each layer, the temperature of each layer, the frequency of incident light, and the frequency of reflected light.

The material appearance information visualizing unit 203 receives the material appearance information from the material appearance information manager 201 to visualize the material appearance information to the material appearance information to the user.

Meanwhile, the material appearance information visualizing unit 203 can visualize the material appearance model on a lobe of a spherical coordinate system or a parameter plane. The entire shape can be represented in a 3-dimensional view, but is conveniently represented in a 2-dimensional cross-section for feature editing. The material appearance information visualizing unit 203 may be used to confirm the measuring and fitting information and edit the material appearance information.

The raw material appearance data storage 204-1 stores the raw material appearance data. Meanwhile, the raw material appearance data may include the value of the bi-directional reflectance distribution function. Further, the raw material appearance data may include the value of the color model (for example, RGB color model).

The complex material appearance data storage 204-2 obtains the material appearance data from the material appearance information processed in the material appearance information editor 202 and stores it as the complex material appearance data.

The physical material appearance data storage 204-3 obtains and stores the physical material data from information on materials.

The material appearance model fitting unit 205-1 for a table type receives the raw material data from the raw material data preprocessor 206, converts the material appearance information into the table type, and provides the material appearance information to the material appearance information manager 201.

Meanwhile, the material appearance model fitting unit 205-1 for the table type may receive the raw material data from the raw material data storage 204-1.

The material appearance model fitting unit 205-1 for the table type may receive the complex material data from the complex material data storage 204-2.

The material appearance model fitting unit 205-2 for the BVB receives the raw material data from the raw material data preprocessor 206, converts the material appearance information into the B-spline volume (BRDF) type, and provides the material appearance information to the material appearance information manager 201.

Meanwhile, the material appearance model fitting unit 205-2 for the BVB may receive the raw material data from the raw material data storage 204-1.

Further, the material appearance model fitting unit 205-2 for the BVB may receive the complex material data from the complex material data storage 204-2.

The material appearance model fitting unit 205-3 for the empirical model receives the raw material data from the raw material data preprocessor 206, converts the material appearance information into the empirical model, and provides the material appearance information to the material appearance information manager 201.

Meanwhile, the material appearance model fitting unit 205-3 for the empirical model may receive the raw material data from the raw material data storage 204-1.

Further, the material appearance model fitting unit 205-3 for the empirical model may receive the complex material data from the complex material data storage 204-2.

The material appearance model fitting unit 205-4 for the physical model receives the raw material data from the raw material data preprocessor 206, converts the material appearance information into the mathematical model and the physical model, and provides the material appearance information to the material appearance information manager 201.

Further, the material appearance model fitting unit 205-4 for the physical model may receive the raw material data from the raw material data storage 204-1.

Further, the material appearance model fitting unit 205-4 for the physical model may receive the complex material data from the complex material data storage 204-2.

The material appearance model fitting unit 205-5 for the multi-layered model receives the raw material data from the raw material data preprocessor 206, converts the material appearance information into the multi-layered model, and provides the material appearance information to the material appearance information manager 201.

The material appearance model fitting unit 205-5 for the multi-layered model may receive the raw material data from the raw material data storage 204-1.

The material appearance model fitting unit 205-5 for the multi-layered model may receive the complex material data from the complex material data storage 204-2. The raw material appearance data preprocessor 206 converts the bi-directional reflectance distribution function and the measured data provided from the virtual material appearance measuring unit 207 and the physical material appearance measuring unit 208 into the raw material data type.

The virtual material appearance measuring unit 207 calculates the values defined by the user, the values output from the existing mathematical/physical model, the virtual bi-directional reflectance distribution function in the mixed complex material model, etc., and measures the virtual material appearance.

The physical material appearance measuring unit 208 uses the camera or the spectroscope for the specific material to search the bi-directional reflectance distribution function and measure the physical material appearance.

In all the above-mentioned cases, the apparatus for processing material appearance information may provide the information received through the material appearance information inputting unit 100, the material appearance information of each layer processed through the material appearance information processor 200, and the input and output information of the rendering unit 300 to the user. Further, in this case, the material appearance information can be displayed by a separate display unit (not shown) or the display apparatus.

While certain embodiments have been described above, it will be understood to those skilled in the art that the embodiments described can be modified into various forms without changing technical spirits or essential features. For example, the apparatus for processing material appearance information proposed in the present invention may be implemented in various forms such the method for processing material appearance information, etc., for a different category. Accordingly, the embodiments described herein are provided by way of example only and should not be construed as being limited. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for processing material appearance information, comprising:
a material appearance information inputting unit that receives material appearance information of each layer of a multi-layered material;
a material appearance information processor that processes material appearance information of each layer; and
a rendering unit that performs rendering by using results of the material appearance information process.

2. The apparatus for processing material appearance information according to claim 1, wherein the rendering unit performs rendering by controlling the speed and accuracy of the rendering according to a level considering the light tracing path that traces the paths of incident light or reflected light from materials of each layer.

3. The apparatus for processing material appearance information according to claim 1, wherein the rendering unit performs rendering in consideration of an order of each layer and characteristics of materials of each layer.

4. The apparatus for processing material appearance information according to claim 3, wherein the rendering unit performs rendering of at least one of bi-directional reflectance distribution function (BRDF), refractive index, absorption coefficient, and reflection coefficient among the characteristics of materials of each layer.

5. The apparatus for processing material appearance information according to claim 3, wherein the order of each layer processed and the characteristics of materials of each layer processed are changed by the input of the user, and
the rendering unit performs rendering by using the results changed by the input of the user.

6. The apparatus for processing material appearance information according to claim 1, wherein the material appearance information processor processes at least one of bi-directional distributions function of each layer, thickness of each layer, refractive index of each layer, absorption coefficient of each layer, and reflection coefficient of each layer.

7. The apparatus for processing material appearance information according to claim 1, wherein the material appearance information processor processes at least one of an order of each layer, surface roughness of each layer, color of each layer, an amount of light incident to each layer, an amount of light reflected from each layer, temperature of each layer, frequency of incident light, and frequency of reflected light.

8. The apparatus for processing material appearance information according to claim 1, wherein the material appearance information inputting unit receives at least two material appearance information, and
the material appearance information processor interpolates at least two material appearance information and generates intermediate material appearance information to process the material appearance information of each layer.

9. The apparatus for processing material appearance information according to claim 1, wherein the material appearance information inputting unit receives at least two material appearance information, and
the material appearance information processor separates more than two material appearance information for each incident angle or reflected angle of light for each layer to process the material appearance information of each layer.

10. An apparatus for processing material appearance information, comprising:
a material appearance information inputting unit that receives material appearance information of each layer of a multi-layered material;
a material appearance information processor that processes the material appearance information of each layer and converts it into a B-spline volume type; and
a rendering unit that performs rendering by using results of the material appearance information processor.

11. The apparatus for processing material appearance information according to claim 10, further comprising:
a multi-resolution calculating unit that generates a B-spline volume bi-directional reflectance distribution function by using the results of the material appearance information processor,
wherein the multi-resolution calculating unit generates the B-spline volume bi-directional reflectance distribution function from the results of the material appearance information processor by controlling the number of control points of the bi-directional reflectance distribution function according to the level of the user desired multi-resolution, and p1 the rendering unit performs rendering by using the B-spline volume bi-directional reflectance distribution function.

12. The apparatus for processing material appearance information according to claim 11, wherein the rendering unit performs rendering by controlling the speed and accuracy of the rendering according to a level considering the light tracing path tracing the incident and reflecting paths of light from the materials of each layer.

13. The apparatus for processing material appearance information according to claim 11, wherein the rendering unit performs rendering in consideration of an order of each layer and characteristics of materials of each layer.

14. The apparatus for processing material appearance information according to claim 13, wherein the order of each layer processed and the characteristics of materials of each layer processed are changed by the input of the user, and
the rendering unit performs rendering by using the results changed by the input of the user.

15. The apparatus for processing material appearance information according to claim 10, wherein the material appearance information inputting unit receives at least one of measured material appearance information, mathematical material appearance information, and material appearance information of a material appearance network and processes the material appearance information of each layer by using each information and converts it into the B-spline volume type

16. A method for processing material appearance information, comprising:
receiving material appearance information of each layer of a multi-layered material;
processing material information of each layer; and
performing rendering by using the results of the processing.

17. The method for processing material appearance information according to claim 16, further comprising converting the material appearance information into a B-spline volume type by using the results of the processing.

18. The method for processing material appearance information according to claim 17, further comprising generating a B-spline volume bi-directional reflectance distribution function by using the results of the conversion,
the generating is generating the B-spline volume bi-directional reflectance distribution function from the results of the conversion by controlling the number of control points of the bi-directional reflectance distribution function according to the level of the user desired multi-resolution, and
the rendering performs rendering by using the B-spline volume bi-directional reflectance distribution function.

19. The method for processing material appearance information according to claim 16, wherein the rendering performs rendering by controlling the speed and accuracy of the rendering according to a level considering the light tracing path that traces paths of incident light or reflected light from materials of each layer.

20. The method for processing material appearance information according to claim 16, wherein the rendering performs rendering in consideration of order of each layer and characteristics of materials of each layer.
